(19) United States
(12) Patent Application Publication
(10) Pub. No.: US 2025/0282953 A1
(43) Pub. Date: Sep. 11, 2025

(54) Composite Materials Having Natural Granular Materials or Soils and Hydrophobic Biologically-derived Binders

(71) Applicant: The Board of Trustees of the Leland Stanford Junior University, Stanford, CA (US)

(72) Inventors: Michael D. Lepech, Stanford, CA (US); Barney Haoyun Miao, Stanford, CA (US)

(21) Appl. No.: 19/069,771

(22) Filed: Mar. 4, 2025

Related U.S. Application Data
(60) Provisional application No. 63/561,559, filed on Mar. 5, 2024.

(51) Int. Cl. C08L 97/00; C08H 7/00; C08K 3/013

(52) U.S. Cl. CPC C08L 97/005; C08H 6/00; C08K 3/013

(57) ABSTRACT

A biopolymer-bound soil (BSC) composite is provided which is a lignin-based BSC that uses lignin as a biopolymer binder. Two types of lignin-hydrolysis lignin and alkali lignin-were studied, and both biopolymers yielded viable biocomposites with similar compressive strength. Considering both types of lignin, compressive strength were achieved ranging from 1.6-8.1 MPa, which, according to ASTM C129, allows lignin-based BSC to be used for non-structural construction applications (e.g., pavement, roofing tiles, and non-structural elements), but not for structural construction applications (structural members where OPCC is used). Lignin-based BSC opens a significant new arena in the field of sustainable construction materials.

### CROSS-REFERENCE TO RELATED APPLICATIONS

This application claims priority from U.S. Provisional Patent Application 63/561,559 filed Mar. 5, 2024, which is incorporated herein by reference.

### FIELD OF THE INVENTION

This invention relates to methods of making composite materials using a raw form of lignin as a binder with granular matter.

### BACKGROUND OF THE INVENTION

Biopolymer-bound soil composite (BSC) shows promise as a potential substitute for concrete, bricks, and other rigid construction materials. Unlike concrete, which uses Portland cement, BSC uses various biopolymers, such as proteins, starches, and others to solidify soil. This strategy is intended to reduce carbon emissions associated with concrete production, which accounts for approximately 8% of global carbon emissions. BSC requires aggregate, a biopolymer and a solvent that is capable of dissolving the biopolymer. Removal of the solvent by evaporation or other forms of desiccation allows BSC to develop its strength. BSC has strength similar to that of conventional construction materials, but a much lower life cycle impact. The development of BSC is part of larger push towards developing more sustainable construction materials to help reduce the carbon footprint of the built environment. The invention addresses these goals.

### SUMMARY OF THE INVENTION

Biopolymer bound soil composites (BSCs) are a new class of sustainable materials that have been explored as alternatives towards soil improvement and other construction applications using biological binders, many of which can be sourced from waste streams. However, current BSC designs do not cover methods for re-using BSCs at the end of life. This invention addresses these limitations by introducing a novel framework for the life cycle design of sustainable hydrophobic Lignin BSCs.

Lignin is a prime candidate for BSC development because of its abundance and availability in areas with high demand for cement. Additionally, as Lignin is a hydrophobic biopolymer, its use in BSCs will help provide increased durability against external exposure to moisture or precipitation.

A framework for the life cycle design of Lignin based building materials is introduced in this invention, where a non-aqueous solvent (dimethyl sulfoxide) is mixed with aggregate and Lignin binder to form Lignin BSCs. As is the case for other mass-produced construction materials (ordinary Portland cement and asphalt concrete), the design of BSCs is driven by key metrics of material composition that relate to target material properties. Experimental samples (cylinders of height=52.0 mm and diameter=25.4 mm) were developed for four main types of lignin at different mix designs. Compressive testing of these samples was carried out, and predictive values of biopolymer content, biopolymer saturation ratio, and dry bulk soil densities were analyzed. These features are used to develop a material design guide for different types of lignin, which allows for the design of Lignin BSCs for a given target compressive strength. Results from these samples indicate that Lignin BSCs can be used for non-load bearing applications according to ASTM C55.

To determine the carbon footprint of Lignin BSCs, a life cycle assessment was conducted comparing a unit-sized Lignin BSC block to those made of conventional materials. The results from the analysis showed that Lignin BSC is a potentially carbon negative material, because carbon rich lignin is embodied into the BSC. An estimate of the life cycle carbon footprint of Lignin BSCs was also determined, which allows for the design of Lignin BSC materials for a target life cycle carbon footprint and a target compressive strength.

The embodiments of the invention are further summarized as a method of making lignin-based composites. A first is step is to obtain or have a raw-form of lignin which is defined as lignin obtained from a manufacturer without any further chemical processing done to the obtained lignin. The raw-form of lignin can be obtained from the manufacturer using a kraft process, a hydrolysis process, or a sulfonation process. Second, the raw-form of lignin is dissolved into a solvent thereby forming a lignin-glue. The lignin-glue is then mixed with aggregates to form a composite, where the lignin-glue binds to the aggregates in the composite. Examples of aggregates are sand, gravel, or soil. Other examples of aggregates are a regolith matter or a granular matter.

The invention can also be embodied as a method of reusing lignin-based composites to make a new recycled lignin-based composite. A first step is to obtain or have recycled lignin-based composite aggregates, where the recycled lignin-based composite aggregates are defined as a material obtained from crushing of lignin-based composites at an end of a design life. Second a solvent is added to reactivate a lignin binder on the recycled lignin-based composite aggregates. The reactivated lignin-based composite aggregates is then mixed to form or reform a new recycled lignin-based composite.

The present invention can also be embodied as a method of making lignin-based composites. In this method one would have a raw-form of lignin, where the raw-form of lignin is defined as a hydrophobic and non-synthetic lignin obtained from a manufacturer without any further chemical processing done to the obtained hydrophobic lignin. The raw-form of lignin is obtained from the manufacturer using a kraft process, a hydrolysis process, or an alkali process. The raw-form of lignin is dissolved into a solvent thereby forming a lignin-glue and where the solvent has fully been evaporated or dissolved at a temperature less or equal than 60 degrees Celsius, at an atmospheric pressure of less or equal than 1 atmosphere and within 7 days. The lignin-glue is then mixed with aggregates (e.g. sand, gravel, or soil, or the aggregate is a regolith matter or a granular matter) to form a composite, where the lignin-glue binds to the aggregates in the composite, wherein there is at least 5 percent by mass of lignin in the composite.

The present invention can also further be embodied as a method of reusing lignin-based composites to make a new recycled lignin-based composite. In this method one would have recycled lignin-based composite aggregates, where the recycled lignin-based composite aggregates are defined as a material obtained from crushing of lignin-based composites at an end of a design life. A solvent is then added to reactivate a lignin binder on the recycled lignin-based composite aggregates, where the solvent has fully been evaporated or dissolved at a temperature less or equal than 60 degrees Celsius, at an atmospheric pressure of less or equal than 1 atmosphere and within 7 days. The reactivated lignin-based composite are then mixed with aggregates (e.g. sand, gravel, or soil, or the aggregate is a regolith matter or a granular matter) to reform a new recycled lignin-based composite wherein there is at least 5 percent by mass of lignin in the composite.

The present invention can still further be embodied as a method of enhancing the strength of manufactured lignin-based composites using mixed solvents. The method uses a mixed solvent composed of water and non-aqueous solvents for enhancing a binding strength of a lignin glue. The raw-form of lignin is then dissolved into the mixed solvent, where the mixed solvent has been evaporated or dissolved at a temperature less or equal than 60 degrees Celsius, at an atmospheric pressure of less or equal than 1 atmosphere and within 2 days. The enhanced lignin-glue is the mixed with aggregates (e.g. sand, gravel, or soil, or the aggregate is a regolith matter or a granular matter) to form a stronger composite, where the enhanced lignin-glue binds to aggregates in a composite, wherein there is at least 5 percent by mass of lignin in the composite. The lignin glue here can be formed through acetylation of a lignin biopolymer when a mixed solvent composed of water and acetic acid is used.

Another embodiment pertains to the percent of lignin dissolved into solution (this is accounted for by the “5 percent of lignin by mass in the finished composite”), where the lignin dissolved in solution is at least 20 percent by mass in the solvent to create a “useful” (a material that is strong enough) lignin glue. The at least 20 percent by mass of lignin dissolved into solvent would not be obvious to a skilled artisan, as it is the minimum limit for any useful lignin-based composite to be made—it would be better to have a composite with higher lignin content as it will result in a stronger composite.

### BRIEF DESCRIPTION OF THE DRAWINGS

For interpretation of the gray-scale in the figures, the reader is referred to priority document U.S. Provisional Patent Application 63/561,559 filed Mar. 5, 2024, which is incorporated herein by reference, where color diagrams are disclosed of the same figures, where applicable.

FIG. 1 shows according to an exemplary embodiment of the invention a Table for design methodology for biopolymer-bound soil composites using lignin.

FIG. 2 shows according to an exemplary embodiment of the invention a lignin-based biopolymer-bound soil composite design sheet.

FIG. 3 shows according to an exemplary embodiment of the invention main types of technical lignins and associated information on biomass type, production volume, and current commercial applications. For this invention, alkali lignin and hydrolysis lignin were investigated extensively to produce lignin-based BSC materials.

FIG. 4 shows according to an exemplary embodiment of the invention lignin-based BSC specimens used in this Study. The cylindrical specimen shown on the left is the type of specimen used for mechanical testing.

FIG. 5 shows according to an exemplary embodiment of the invention experimental mix designs of lignin-based biopolymer-bound soil composites.

FIG. 6 shows according to an exemplary embodiment of the invention design and compressive strength of lignin-based BSC mixes.

FIGS. 7A-D show according to exemplary embodiments of the invention lignin-based BSC for specimen compressive strength against void saturation ratio (FIG. 7A), solvent content (FIG. 7B), biopolymer content (FIG. 7C) and biopolymer content versus dry bulk soil density (FIG. 7D). The error bars correspond to standard deviation.

FIGS. 8A-B show according to exemplary embodiments of the invention lignin-based BSC compressive strength as a function of (FIG. 8A) unit weight, and (FIG. 8B) dry bulk soil density. Both vertical and horizontal error bars correspond to standard deviation.

FIG. 9 shows according to an exemplary embodiment of the invention models for predicting the compressive strength of lignin-based BSCs.

FIG. 10 shows according to an exemplary embodiment of the invention overall percent error of compressive strength of lignin-based BSC in comparison to predicted specimen strengths for different regression models from Eqs. (4)-(7) for all lignin mixes investigated in this invention. The mini-window shows the model percent errors obtained for HL lignin-based BSC and AL lignin-based BSC.

FIGS. 11A-B show according to exemplary embodiment of the invention design relationships for (FIG. 11A) Hydrolysis Lignin-Based BSC and (FIG. 11B) Alkali Lignin-Based BSC. The ‘yellow’ and ‘orange’ regions (see priority document) show the feasible areas for design that are inefficient or more prone to shrinkage cracking respectively. The ‘red’ region (see priority document) represents the infeasible area, based on the maximum dry bulk soil density of the aggregate. The contour region in the plot is the design area of the guide.

FIG. 12 shows according to an exemplary embodiment of the invention ashby plot comparing the compressive strength and density (unit weight) of lignin-based BSC from this study to other conventional materials and types of BSC. The family of ‘gray’ ovals shows the approximate regions of unit weight and compressive strength for various forms of lightweight concrete (LWC) and ordinary Portland cement concrete (OPCC). The family of ‘green’ ovals shows unit weight and compressive strength regions for existing forms of BSC. The ‘yellow’ oval represents the approximate region for lignin-based BSC, with the ‘blue’ and ‘orange’ data points representing the compressive strength and density results obtained in this invention. Materials that meet the requirements of ASTM C129 can be used for non-structural construction applications (pavement/roads, roofing tiles, and non-structural elements), while materials that meet the requirements of ASTM C55 can be used for structural applications. (For interpretation of the references to color in this figure legend, the reader is referred to the priority document).

FIG. 13 shows according to an exemplary embodiment of the invention overall framework for the design and manufacture of lignin-based biopolymer-bound soil composites (BSC). The left portion of the chart shows the design procedure/materials available, while the right side shows the procedure for manufacturing lignin-based BSCs.

FIG. 14 shows according to an exemplary embodiment of the invention the mixed solvents that have been used to manufacture lignin-based composite with enhanced strength. At the top, a list of non-aqueous solvents is shown that can be used to make a mixed solvent, while the bottom table details a mixed solvent made from acetic acid and water that can be used to manufacture lignin-based composite.

FIG. 15 shows according to an exemplary embodiment of the invention a plot of the evaporation rate for lignin-based composite. The use of a mixed solvent reduces the time needed for evaporating out the solvent from 7 days to only 2 days.

FIG. 16 shows according to an exemplary embodiment of the invention a plot of the strengths obtained when acetylated lignin blue is used to make lignin-based composite. Where the strengths obtained for lignin-based composite made with acetylated lignin is dependent on the content of acetic acid in the mixed solvent and the temperature for evaporating out the solvent.

FIG. 17 shows according to an exemplary embodiment of the invention overall framework for the design and manufacture of lignin-based biopolymer-bound soil composites (BSC) made from recycled ingredients. The framework shows the end-of-life treatment of lignin-based composite, and how the resulting recycled lignin aggregates can be used in place of virgin lignin and aggregate.

FIGS. 18A-B show according to exemplary embodiments of the invention design relationships for (FIG. 18A) Lignoboost Lignin-Based BSC and (FIG. 18B) Lignoforce Lignin-Based BSC. The ‘yellow’ and ‘orange’ regions (see priority document) show the feasible areas for design that are inefficient or more prone to shrinkage cracking respectively. The ‘red’ region (see priority document) represents the infeasible area, based on the maximum dry bulk soil density of the aggregate. The contour region in the plot is the design area of the guide.

### DETAILED DESCRIPTION

A new form of BSC, which uses lignin as the biopolymer is disclosed herein. Lignin is structurally complex and is composed of a cross-linked three-dimensional structure made of p-hydroxpyhenyl, guaiacyl, and syringyl units. The proportions of these units vary with the source of lignin. Guaicyl units and p-hydroxpyhenyl units predominate in softwood lignin, and guaiacyl units and syringyl units predominate in hardwood lignin. Chemical groups such as hydroxyl, carbonyl, and carboxyl groups also vary based on the source of lignin. Lignin is a waste product from paper and pulp production and from production of cellulosic bio-fuels. Materials originating from untapped industrial waste streams are attractive because they reduce the need for additional raw materials. Currently, around 50-70 million tons of lignin are produced worldwide. With initiatives such as the Renewable Fuel Standard (RFS), the annual production of lignin is forecast to increase 5-fold by 2030 due to an anticipated increase in biofuel production. Lignin is typically considered to be a low-value waste product, where 98%-99% is combusted as fuel. Only 1%-2% of lignin is used in producing higher-value products such as syngas, carbon fibers, and synthetic phenolic compounds. Most lignin (>60% carbon), however, is burned onsite, in the open, leading to significant emissions of carbon into the atmosphere. A more ideal use for lignin would be to incorporate it into construction materials, such as bricks, which will help prevent the generation of harmful pollutants and sequester carbon in the long term.

Studies of construction applications of lignin have been focused on its potential in soil stabilization rather than in forming structural components). The potential of using lignin as a substitute for traditional stabilizers (cement, lime, etc.) has been demonstrated. Conventional soil stabilizers raise soil pH, leading to adverse effects on the environment (groundwater and surrounding vegetation). According to ASTM C55 and ASTMC129, the minimum net area compressive strength for load-bearing and non-structural concrete masonry units are 17.2 MPa and 3.45 MPa. Therefore, lignin-based BSC should have a compressive strength of at least 3.45 MPa to be considered viable for non-structural construction (non-load bearing partition walls, non-load bearing masonry units, etc.).

With this invention, the inventors introduce a novel version of BSC which uses lignin as the biopolymer binder. The inventors use the term “lignin-based BSC” to refer to this new material. To characterize this material, the inventors fabricated a series of test specimens made from different mixtures of sand and lignin, using DMSO to dissolve the lignin. Two different types of lignin were investigated for this innovation, hydrolysis lignin and alkali lignin. These types of lignin were chosen because they come from different industrial processes. Alkali lignin is a byproduct of the paper-making industry. Hydrolysis lignin is a byproduct of the bio-ethanol industry. While not as abundant as other types of lignin, presently, production of hydrolysis lignin is expected to grow, substantially, along with the growth of the bio-ethanol industry. To determine the compressive strength of these materials the inventors performed unconfined, uniaxial compressive strength testing. Lastly, the inventors developed a set of design relationships, which pave the way for use of this material in select construction applications.

### Mixture Design Theory

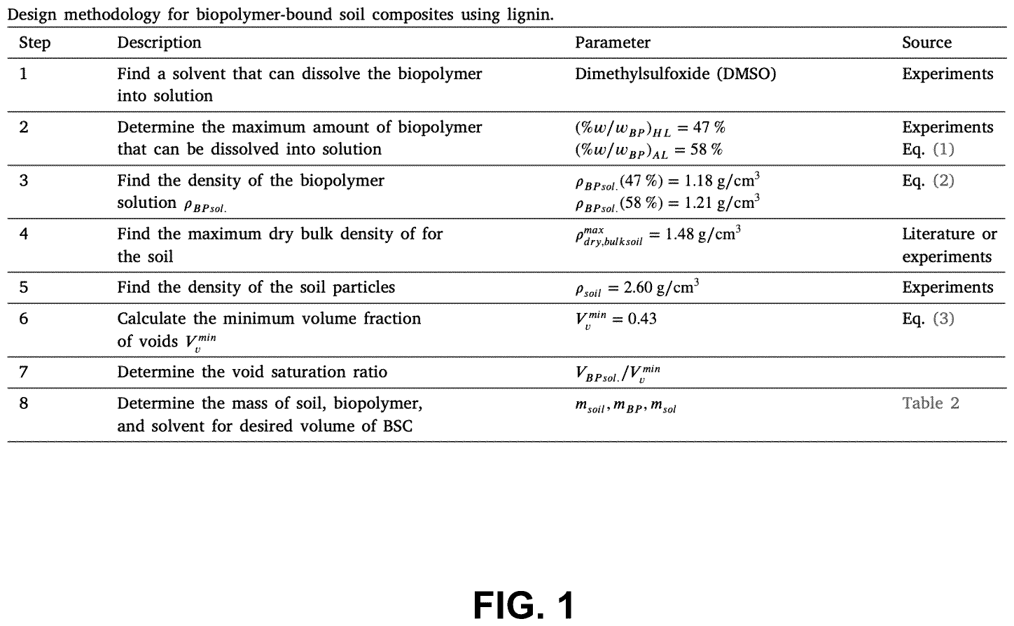

Biopolymer-bound soil composites are comprised of densely packed aggregates, with the inter-particle voids filled by a biopolymer binder. The compressive strength is dependent on the strength of the aggregate, the interfacial bond, and the biopolymer matrix. It has been speculated that the main determinant of BSC's compressive strength is due to the soil particles taking the load, with the biopolymer matrix providing shear resistance. Strategies to increase the strength of BSC include selecting biopolymers with greater mechanical strength and increasing the strength of the interfacial bond between the biopolymer and the aggregate. To determine the optimal mix, the concept of dry bulk soil density is used, where this term refers to the density of the aggregate in the finished (dried) BSC. FIG. 1 shows the proposed mix design framework. Each step is further discussed in this section. The design methodology of lignin-based BSC closely follows prior BSCs, with the main difference being the use of a non-water solvent—DMSO—to dissolve the biopolymer into solution.

Find a Solvent that can Dissolve the Biopolymer

The lignins investigated for the purposes of this invention are hydrolysis lignin (HL) and alkali lignin (AL). Unlike previously explored biopolymers, hydrolysis lignin and alkali lignin are insoluble in water under normal conditions (pH≅7.0). This is an important issue since the biopolymer cannot bond to the aggregate if it does not start out fully dissolved. Therefore, the inventors used DMSO as an alternate solvent, to dissolve lignin at high concentrations (>20%). It is worthwhile to mention that BSCs made from hydrophobic biopolymers will likely have greater durability in wet environments, as compared to BSCs made with hydrophilic biopolymers. BSCs made with hydrophobic biopolymers, such as lignin, may be more effective for outdoor applications without the need for waterproof coatings. A variety of organic solvents are effective in dissolving lignin, including butyl carbitol, dioxane, ethylene glycol, and dimethylsulfoxide (DMSO). For the purpose of this invention, the inventors selected dimethylsulfoxide (DMSO), since it is low cost and poses few safety concerns.

Determine the Maximum Amount of Biopolymer that can be Dissolved into Solution

The maximum amount of biopolymer that can be practically dissolved into solution is limited by the workability limit for the biopolymer, which is defined as the maximum amount of biopolymer (lignin) that can be dissolved into solution such that it does not undergo glass-like kinetic arrest and is still practically workable. Even though literature on the workability limit of lignin is not available, there is a rough estimate based on the workability limit of bovine serum albumin (BSA). The upper limit for BSA solubility, (% w/w_{BP}) max, is 55%. However, with different equipment, one is only able to experimentally achieve 48% solubility. The inventors have found that the upper limits of solubility for the two types of lignin are 47% and 58% for hydrolysis lignin and alkali lignin, in DMSO, respectively. The following equations define the biopolymer concentration, % w/w_{BP}, of the solution:

$$( \% w / {w}_{BP} ) = \frac{{m}_{BP}}{{m}_{BP} + {m}_{solvent}} = \frac{{m}_{BP}}{{m}_{BPSol .}} \qquad ( 1 )$$

where m_{BPSol} is the mass of the solution, which is equal to the combined mass of the biopolymer, m_{BP}, and the solvent, m_{Solvent}.

### Find the Density of the Biopolymer Solution ρ_{BPSol}.

The density of the biopolymer solution changes with the concentration of biopolymer in the solution. Eq. (2) will be used to find the density of the biopolymer solution. For this equation, it is assumed that the temperature of DMSO and the resulting solution is at 25 degrees Celsius and that the partial specific volume of the two lignins are the same. Either of these assumptions will lead to negligible effects on the results produced. The density of the biopolymer solution is given by the following equation:

$$\begin{matrix}{ρ}_{BPsol .} = \frac{1}{\sum {m}_{i} {\overline{v}}_{i}} \\ = \frac{1}{\% w / {w}_{BP} * a + ( 1 - \% w / {w}_{BP} ) * b}\end{matrix} \qquad ( 2 )$$

$$a = 0.769 {cm}^{3} / g , b = 0.9128 {cm}^{3} / g$$

where a is the partial specific volume of alkali lignin and bis the partial specific volume of DMSO at 25 degrees Celsius.
Find the Maximum Dry Bulk Density of the Soil being Used in the Mix

Similar to ordinary Portland cement concrete, a higher fraction of soil per unit volume is correlated with greater compressive strength for BSC. In the case of soil-based materials, the dry bulk density is dependent on the solvent content, Solv_{c}, and compaction methods used to manufacture specimens. The inventors used a double compaction method to manufacture test specimens according to a modified version of ASTM standard C29 (ASTM, C29 et al., 2009). Using the same aggregate and the same double compaction method shows that the maximum dry bulk density for Grade 90 sand,

ρ_{dry,bulksoil}^{max}, is 1.48 g/cm3.

### Find the Density of the Soil Particles

The density of the soil particles can be found on product information sheets or through laboratory experiments (ASTM D854). In this invention, Grade 90 sand was used, which has a soil particle density, ρₛₒᵢₗ, of 2.60 g/cm3.

Calculate the minimum volume fraction of voids V_{c}^{min}

To achieve a mix that has optimal strength and is efficient in biopolymer usage, the volume of the biopolymer solution, V_{BPSol}, must not exceed that of the voids,

Vv, at the maximum bulk density. The minimum void fraction, Vᵥ^{min}, refers to the void volume (Vᵥ), at the maximum bulk density of the soil before the addition of biopolymer.

$${V}_{v}^{min} = 1 - \frac{{ρ}_{dry , bulksoil}^{max}}{{ρ}_{soil}} \qquad ( 3 )$$

### Determine the Void Saturation Ratio

To achieve the most efficient design for a given concentration of biopolymer in solution, the volume of voids should be filled completely with biopolymer solution. Therefore, the void saturation ratio,

V_{BPsol.}/Vᵥ^{min}, is calculated for each mix, with the preference being to design mixes with void saturation ratios near 1.

### Calculate the Mass of Soil, Biopolymer, and Solvent to Manufacture Desired Amount of BSC

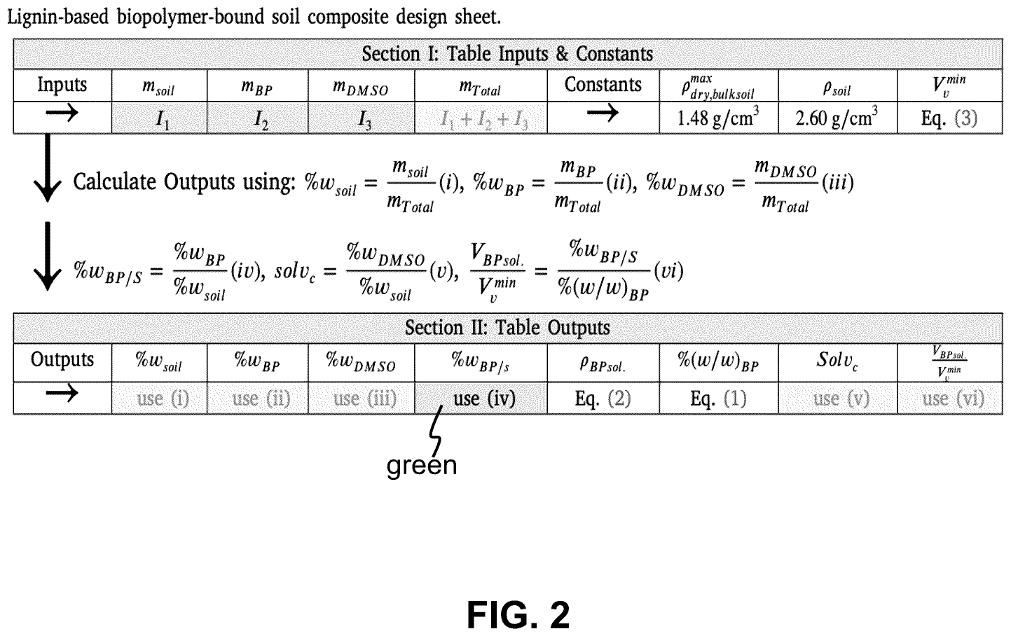

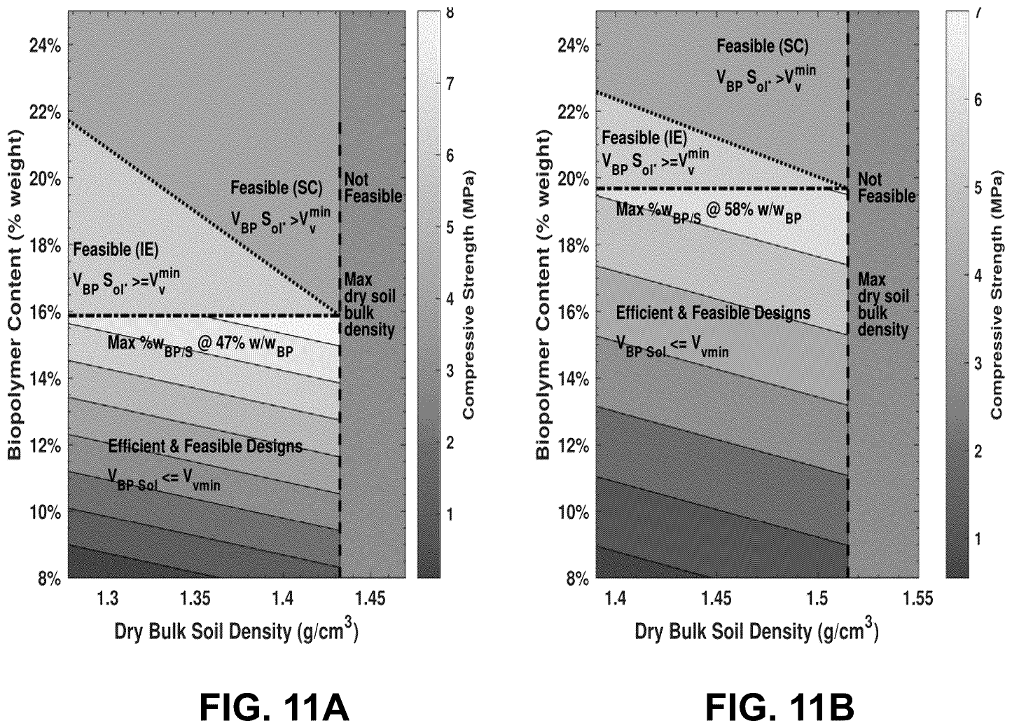

To manufacture the desired amount of BSC, the mass of soil, biopolymer, and solvent needed is found in FIG. 2, which depicts the design sheet for lignin-based BSC mixes. For a given total mass of BSC, the user inputs (I₁, I₂, I₃), shown by the yellow cells, are varied until the designed void saturation ratio (V_{BPsol.}/Vᵥ^{min}) and biopolymer concentration, (% w/w_{BP}) max, are satisfied. The inputs of the table are used to calculate the outputs of the table. The output representing biopolymer-to-soil ratio (% w_{BP/s}) is highlighted in ‘green’ in FIG. 2 as it can be used in conjunction with the design relationships (shown later in FIGS. 11A-B) presented in this invention to tailor lignin-based BSC for a target compressive strength.

### Experimental Methods and Materials

### Aggregate and Solvent

Feldspathic grade 90 sand (#90 Silver Sand), from P. W. Gillibrand, Simi Valley, California, was used for all experiments. The physical properties of this material, as reported by the manufacturer, were grain shape—sub-angular; hardness—6.5 Mohs; moisture content—<0.1%; bulk density—1409 k g/m3; soil particle density—2.60 g/cm³; and uniformity coefficient 1.75-1.95. DMSO, reagent grade, was selected as the solvent and obtained from Fisher Scientific.

### Overview of Technical Lignins

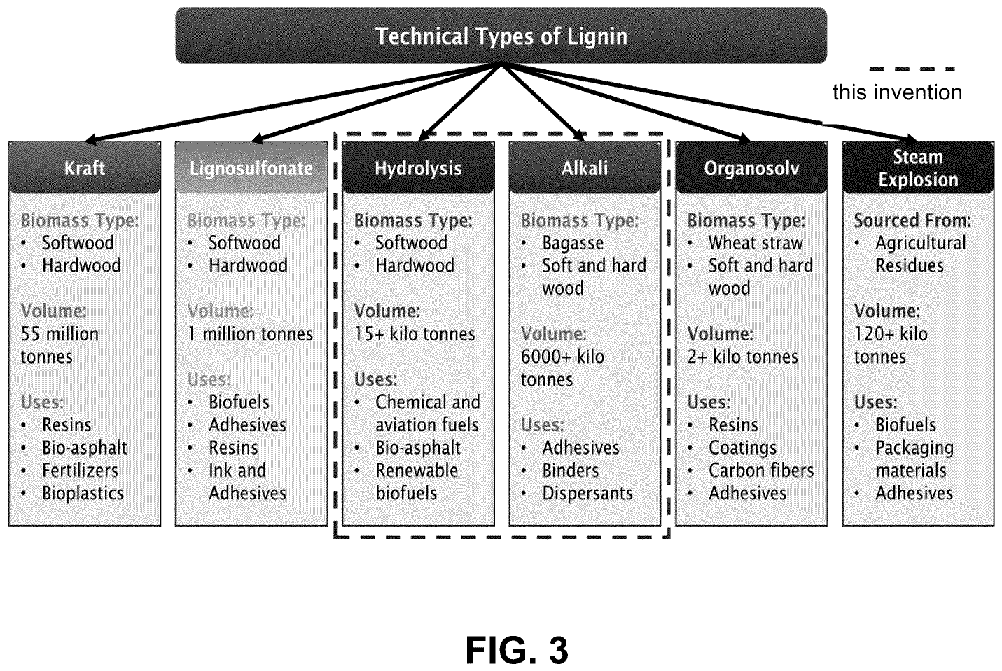

There are many types of lignin, including kraft lignin (lignoboost lignin and lignoforce lignin), alkali lignin (soda), steam expansion lignin, hydrolysis lignin, organosolv lignin, and lignosulfonate lignin. FIG. 3 shows the different types of biomass from which various lignins are derived, known production volumes per year, and current uses of each type of lignin. Alkali lignin and hydrolysis lignin were selected for this invention. Kraft lignin and lignosulfonate lignin comprise more than 90% of global lignin production. While alkali lignin is sometimes referred as kraft lignin, they are not identical. Alkali lignin has a higher molecular weight, more arylglycerol groups, and more enol-ether linkages than kraft lignin. Alkali lignin also has an estimated 8%-14% phenylglycerol structure, which is much higher than that of kraft lignin. Hydrolysis lignin is a byproduct of bioethanol production, unlike alkali lignin and kraft lignin, which are products from the paper and pulp industry. By selecting alkali lignin and hydrolysis lignin, the inventors are choosing lignins from two different industrial sources with the desire to generalize the applicability of the design principle shown in this invention.

### Lignin Sources

Alkali lignin was obtained from Sigma-Aldrich (product #471003), with average molecular weight of 10,000 (Sigma Aldrich, 2023). Hydrolysis lignin was obtained from Shell International Exploration and Production, Inc., and produced by a mild acid pretreatment protocol and enzymatic hydrolysis for 2G bioethanol production, with an average molecular weight estimated to be 22,000. No chemical modification (e.g., functionalization) was performed on either type of lignin prior to use for manufacturing lignin-based BSC.

### Specimen Manufacturing and Testing

Before using hydrolysis lignin, the material was dry sieved using a 2 mm brass mesh sieve, to remove twigs and inorganic matter larger than 2 mm. For the alkali lignin, no sieve was needed. To make a lignin-based BSC mix, the lignin was first dissolved into DMSO by stirring with the aid of a KitchenAid stand mixer (Pro 500 Series 10). The process of dissolving the lignin was facilitated by the step-wise addition of DMSO. The process of dissolving the lignin took approximately 5-10 min.

After fully dissolving the lignin, the lignin solution and grade 90 sand were added to a mixing bowl. The stand mixer was used to blend the mixture for 5 min until the sand-DMSO-lignin mixture was uniform. A custom cylindrical molding apparatus measuring 13 mm inner diameter and 76 mm height, made from 316 stainless steel, was used to form the cylindrical shapes of the BSC specimens. A piston with a 12.8 mm diameter and 84 mm height was used to compact the specimens in the mold before the specimens were extruded and desiccation was begun. The compaction was performed using an MTS Criterion Model 43 electromechanical universal testing machine. Double 5 MPa compaction was implemented, which involves end-over-end compaction of each specimen. After double 5 MPa compaction, cylindrical specimens were extruded from the mold by pushing on the piston. The height and weight of the specimens were measured before being placed in an oven (Fisher Scientific IsoTemp) at 60 degrees Celsius until DMSO was completely removed. The degree of desiccation can be calculated by starting with the mass of DMSO in each specimen at the time of fabrication and tracking the mass loss over time. Complete desiccation of lignin-based BSC (i.e, 100% DMSO removal) takes approximately two weeks. After completion of desiccation, the specimens were sanded on both ends with the heights and masses again being measured before and after sanding. The heights and diameters of the specimens were measured at least 3 times using digital calipers that are accurate to the nearest 0.05 mm.

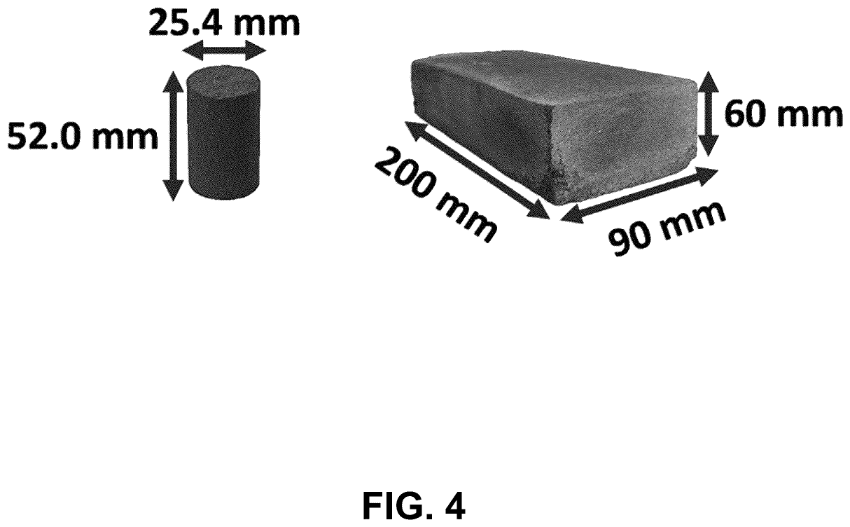

After being sanded, the specimens were subjected to unconfined uni-axial compression tests using an MTS Criterion Model 43 electromechanical universal testing machine, to determine ultimate compressive strength. The ultimate compressive strength was found by dividing the peak load (load at specimen failure) by the average cross-sectional area of the specimens. The tested specimens had roughly the same heights (+1 mm) and diameters (+0.50 mm). Specimens that did not fall within these dimensions were left out of the study. FIG. 4 shows a typical compressive strength testing specimen used in this study, along with a brick made from lignin-based BSC.

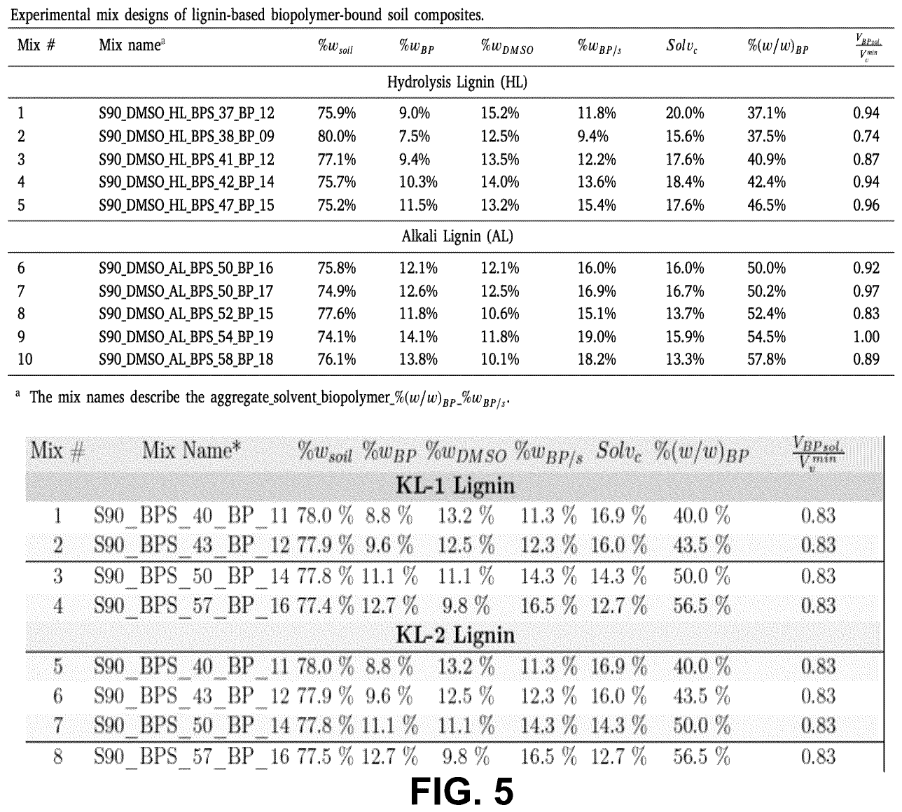

FIG. 5 shows the ten successful mixes that were prepared and tested during this study (five mix designs for each type of lignin). The mix name contains information regarding the type of aggregate (grade 90 sand), solvent (DMSO), biopolymer (alkali lignin or hydrolysis lignin), percent biopolymer in solution (% (w/w) B P), and biopolymer-to-soil ratio (% w_{B P/s}).

### Experimental Results

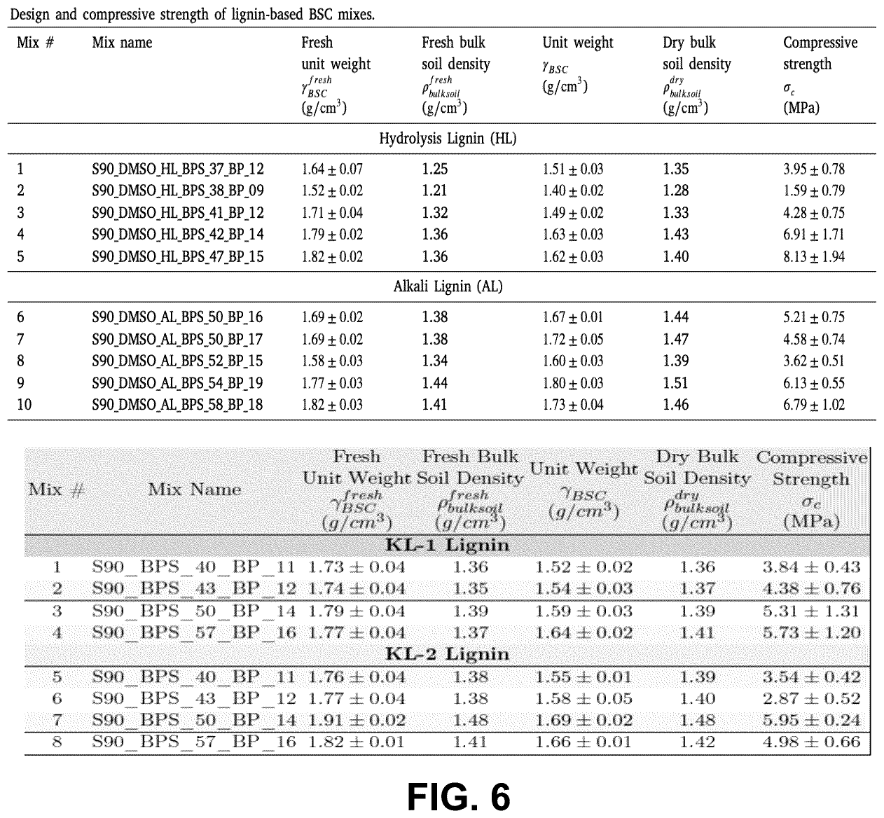

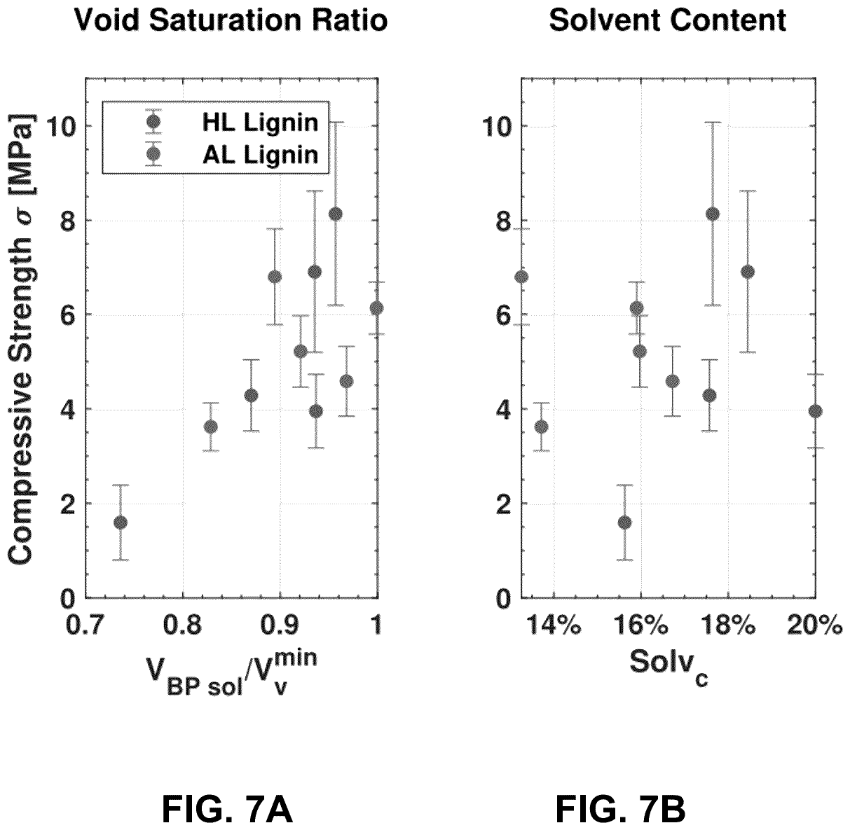

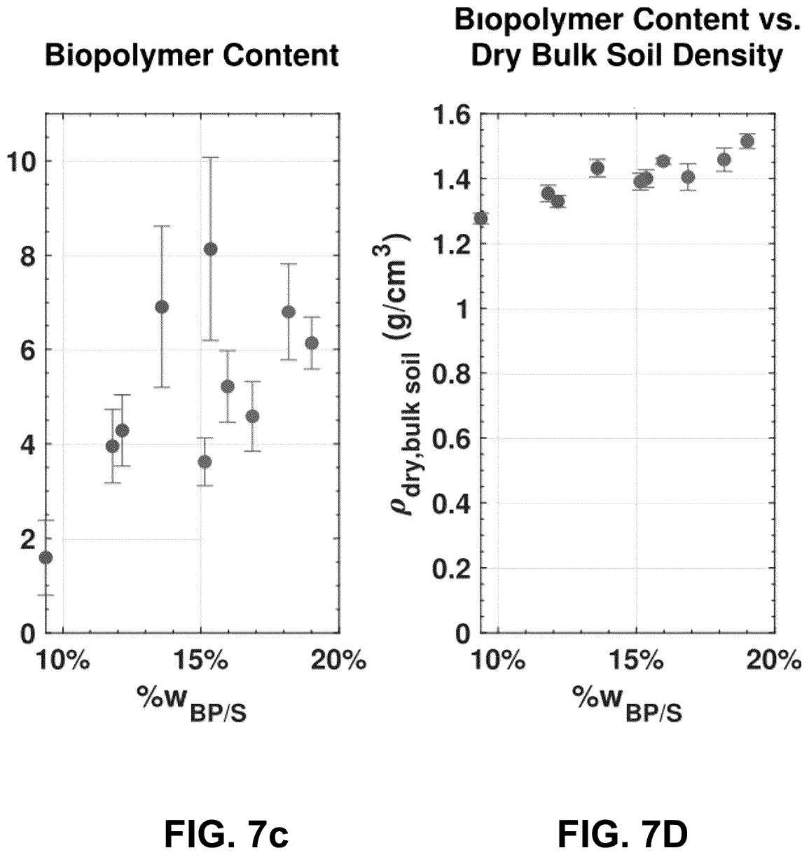

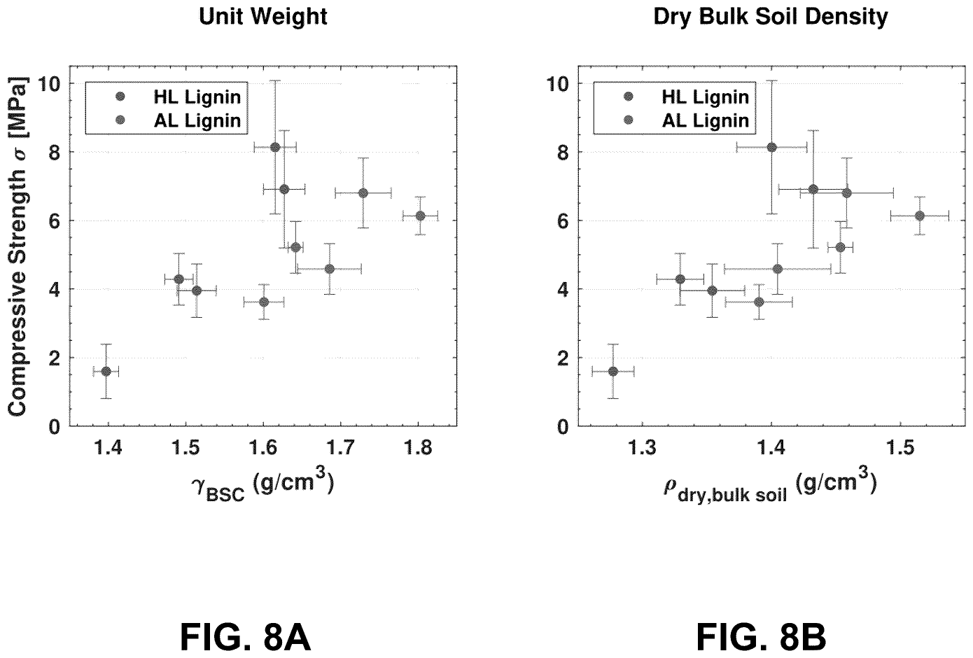

Results of unconfined uniaxial compression tests of lignin-based BSC specimens are shown in FIG. 6. For each mix, 8-10 specimens were prepared. Average compressive strength and standard deviation for these measurements are shown in FIG. 6. The relationships between mix parameters (void saturation ratio, solvent content, and biopolymer content) and experimentally obtained compressive strength and densities (unit weight and dry bulk soil density) are shown in FIGS. 7A-D and FIGS. 8A-B.

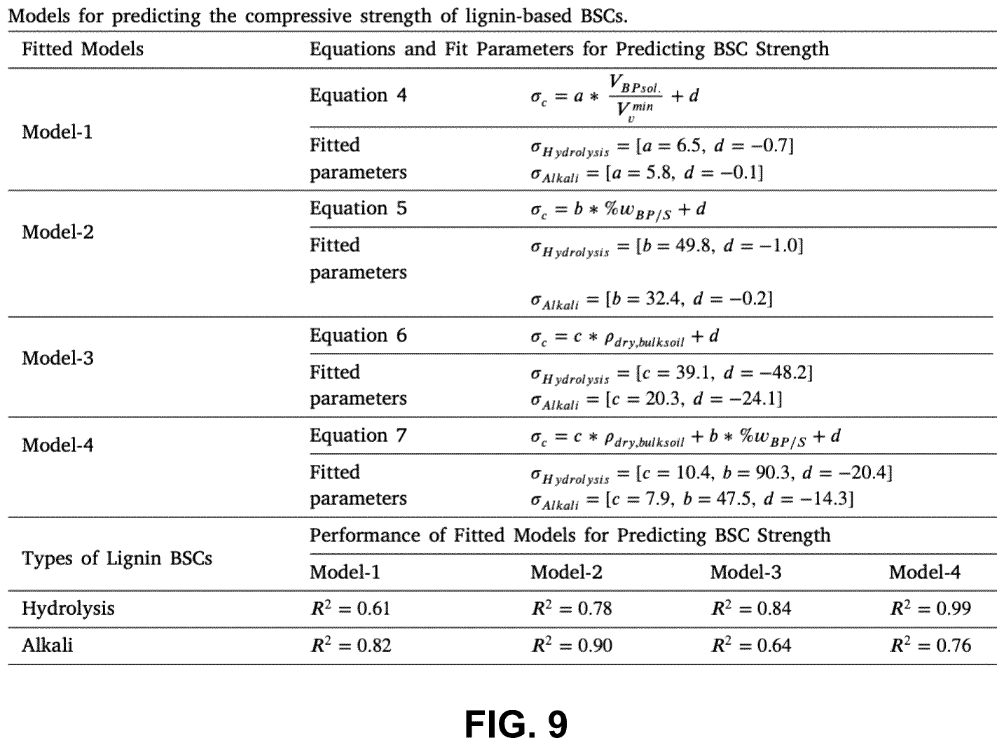

A linear model appears to adequately account for the relationship between compressive strength and void saturation ratio, as shown in FIG. 7A. To fit the relationship between compressive strength and void saturation ratio, a zero point was added to the fit. This is because of the physical relationship between compressive strength and void saturation ratio, as specimens with near zero void saturation ratio will have strengths that are near zero (no biopolymer in the voids of the composite). The equation that describes this relationship for each type of lignin-based BSC is shown in FIG. 9 Eq. (4).

$${σ}_{c} = a * \frac{{V}_{B P sol .}}{{V}_{v}^{min}} + d \qquad ( 4 )$$

A linear model also appears to account for the relationship between compressive strength and biopolymer content (FIG. 7C). As per the void saturation ratio, a zero point was added to the relationship between compressive strength and biopolymer content, as BSC with near zero biopolymer (no biopolymer in the BSC) content will have a near zero compressive strength. Eq. (5) describes this relationship for each type of lignin-based BSC and is shown in FIG. 9.

$${σ}_{c} = b * \% {w}_{BP / S} + d \qquad ( 5 )$$

FIGS. 8A-B depict the relationship between unit weight and dry bulk soil density, respectively, with compressive strength for each type of lignin-based BSC. The inventors chose not to develop a model relating unit weight and compressive strength, because unit weight is a variable that is based on both partial soil density and partial density of the biopolymer. Dry bulk soil density is a better choice because it is independent of biopolymer content. Unlike biopolymer content and void saturation ratio, which can be specified in the mix design, dry bulk soil density can only be determined after the fabrication of a BSC specimen. The dry bulk soil density, (partial soil density), g/cm³, is arrived at by determining the unit weight (specimen density), g/cm³, and subtracting the partial density of biopolymer, g/cm³. Lignin-based BSC with higher dry bulk soil density, exhibits higher compressive strength, as shown in Eq. (6).

$${σ}_{c} = c * {ρ}_{dry , bulksoil} + d \qquad ( 6 )$$

Physically, the dry bulk soil density is analogous to the degree of soil packing within the composite. Thus, BSCs with a higher dry bulk soil density will have soil particles that are more tightly packed together, and as a result, will have greater compressive strength. FIG. 7D depicts the relationship between biopolymer content and dry bulk soil density. For each type of lignin-based BSC, a higher amount of biopolymer content was correlated with a higher dry bulk soil density. This makes sense, physically, as there are potentially more inter-particle interactions/biopolymer bridges that form in BSC that uses more biopolymer. Thus, the inventors expect that BSC with a higher biopolymer content will have soil grains that are more tightly bound, resulting in greater dry bulk soil density.

Biopolymer content and dry bulk soil density were better correlated with compressive strength than was void saturation ratio (FIG. 7A) for both types of lignin-based BSC. The inventors considered the possibility that a model based on both biopolymer content and dry bulk soil density might show an even better correlation with compressive strength than the univariate models. A linear regression using both biopolymer content and dry bulk soil density showed an overall marginal improvement over uni-variate models for lignin-based BSC. Since, there was not an obvious correlation between solvent content and compressive strength, the inventors did not apply a regression model to the data in FIG. 7B.

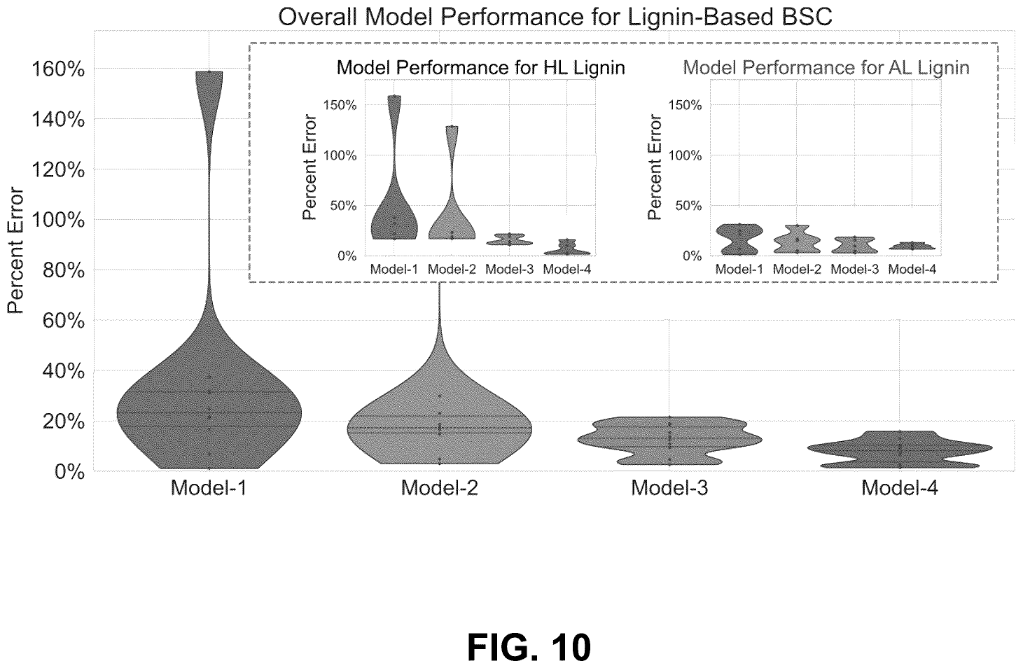

FIG. 10 shows the overall performance of the four linear regression models shown in FIG. 9 for various lignin-based BSC mixes. Percent error was defined as the difference between the predicted compressive strength and the actual compressive strength for each experiment data point. Considering the combined data (for both hydrolysis lignin and alkali lignin), the four models showed similar ability to predict ultimate compressive strength, as judged by the R² values (as shown in FIG. 9).

Model-4, which uses both dry bulk soil density and biopolymer-to-soil ratio (biopolymer content) as independent variables demonstrated slightly higher predictive ability.

The inventors created contour plots to show the relationship between the variables dry bulk soil density and biopolymer-to-soil ratio, in relation to compressive strength. The contour regions of FIGS. 11A-B represent the efficient and feasible design area (void saturation ratio is lower than 1). The ‘yellowish-orange’ and ‘orange’ regions (see priority document) of the design relationships depict the feasible but inefficient (IE) and feasible but subject to shrinkage cracking (SC) regions. Feasible but inefficient (IE) refers to mixes that are potentially feasible to make, but are inefficient since too much biopolymer solution has been added to the mixture. The feasible but subject to shrinkage cracking (SC) region shows mixtures that are inefficient and also more likely to experience shrinkage cracking. Finally, the red region of the figure depicts the infeasible region, as there are no specimens that can have a dry bulk soil density greater than the maximum dry bulk soil density.

### Discussion of Results

The results show that for lignin-based BSC, hydrolysis lignin is a more effective biopolymer than alkali lignin from the standpoint of compressive strength. This is evident from a comparison of the results for mix #5 and mix #6, which had very similar biopolymer content. Specimens made from mix #5 had a compressive strength of 8.1 MPa and specimens made from mix #6 had a compressive strength of 5.2 MPa. The difference between hydrolysis lignin-based BSC and alkali lignin-based BSC, in terms of compressive strength, is also evident in FIG. 7C, which shows a steeper slope for hydrolysis lignin-based BSC versus alkali lignin-based BSC, as judged by the fitted parameters from the linear regression (Model-2, Eq. (5), in FIG. 9). The slope relating biopolymer content and compressive strength was 49.8 for hydrolysis lignin-based BSC and 32.4 for alkali lignin-based BSC. Although the difference in slope was not significant at the 95% confidence level, it was significant at the 75% confidence level (data not shown). Additional data or tests exploring the mechanical properties of the biopolymer or interfacial bond strength between the biopolymer and aggregate, may help to confirm and determine the underlying reasons that lead to this apparent difference between hydrolysis lignin-based BSC and alkali lignin-based BSC.

Since dry bulk soil density is a predictor of BSC compressive strength, the inventors considered the possibility that the higher compressive strength that the inventors measured for hydrolysis lignin-based BSC versus alkali lignin-based BSC might be due to higher dry bulk soil density in the finished specimens of hydrolysis lignin-based BSC. However, the inventors observed only a small difference in dry bulk soil density for the two types of lignin-based BSC, with the alkali lignin-based BSC specimens actually having the higher dry bulk soil density, not the hydrolysis lignin-based BSC specimens. It was concluded that the higher compressive strength of hydrolysis lignin-based BSC is due to a fundamental difference between the two biopolymers, and not due to a difference in the resulting dry bulk soil density for the finished specimens. The greater strength of biopolymer bridges between sand particles or greater strength of the interface between the biopolymer and the sand particles for hydrolysis lignin versus alkali lignin likely accounts for the observed difference in compressive strength. Future studies involving simple tests performed on dried samples of lignin, by itself, may help to address this topic. While this invention focused on the design and manufacture of lignin-based BSC, further investigations into the microstructure of lignin-based BSC are needed to better understand the interactions (pore-pore, soil-soil, and soil-biopolymer) between the phases of the composite.

The maximum strength for BSC is achieved when (1) the concentration of biopolymer dissolved into the solution is at maximum and (2) the voids of the BSC are fully filled (i.e., V_{B P sol}/Vₘᵢₙ=1). The maximum biopolymer concentration (% w/w_{B P}) in DMSO with our given equipment was 47% for hydrolysis lignin and 58% for alkali lignin. A practical limitation to the maximum solubility of lignin in DMSO relates to the workability of the lignin solution, which can become quite viscous as the concentration of lignin approaches the solubility limit.

The design relationships shown in FIGS. 11A-B were developed using the experimental results of this study and allow users to implement lignin-based BSC in non-structural construction applications. FIGS. 7A-D and FIGS. 8A-B show that the relationships between compressive strength and key mix parameters can be approximated as linear relationships within the limits of the data quality of this invention.

Lignin is a naturally occurring biopolymer which is underutilized but has great potential for use in construction materials. The development of sustainable lignin-based BSC is significant for three reasons: (1) being the first application of a non-protein plant-derived biopolymer from a waste stream in BSC, (2) the first instance of use of a hydrophobic (non-water soluble) biopolymer in forming BSC, and (3) being a major step towards the development of a sustainable construction material. The development of BSC using a hydrophobic biopolymer is attractive as it indicates that this version of BSC will likely exhibit better resistance to water exposure without the need for protective coatings. Although the strength of lignin-based BSC is lower than previous BSC using bovine serum albumin or other blood-proteins, BSC made with lignin is still promising as it can be used in the construction industry for non-structural applications (e.g., pavement, non-load-bearing-walls, etc.).

Additionally, the development of lignin-based BSC provides three obvious benefits: (1) reduction of the high carbon footprint associated with the production of conventional construction materials, (2) a new way to utilize increasing amounts of lignin resulting from the growth of bioethanol production, and (3) reducing the emission of carbon from the combustion of lignin when it is not used for material production. Lignin-based BSC utilizes lignin as a biopolymer binder to provide strength in the composite material. In comparison to prior BSC made with blood-proteins, lignin-based BSC provides better carbon sequestration due to the greater carbon richness of lignin (lignin≈60% carbon and bovine serum albumin≈45% carbon). Hence, the sequestration of carbon-rich lignin in lignin-based BSC is yet another benefit that helps make lignin-based BSC a sustainable alternative to conventional construction materials.

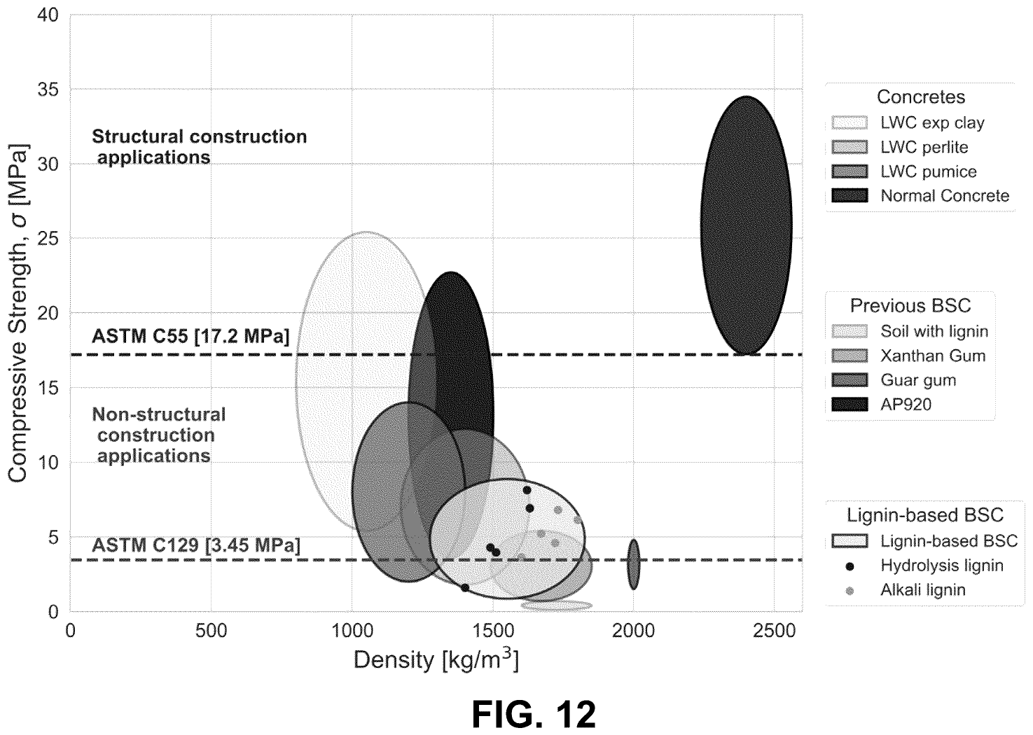

FIG. 12 shows the range of density (unit weight) and compressive strength of lignin-based BSC in comparison to existing BSC and conventional materials (variants of lightweight concrete and ordinary Portland cement concrete). Lignin-based BSC is less dense than conventional construction materials. By having a lightweight material, the dead load of lignin-based BSC will be lower than that of many materials, and allow users more flexibility in design. In comparison to other variants of BSC, lignin-based BSC has a similar compressive strength to BSC made from various gums (xanthan gum and guar gum), but a lower compressive strength compared to BSC made from animal blood plasma (AP920).

Currently, lightweight concrete (specifically, concrete made using lightweight aggregate) is used to produce a variety of lightweight structural members and non-structural building elements. These include pre-cast wall panels, interior partition walls, roofing tiles, and other types of facade applications. Any of these applications are viable paths for introducing lignin-based BSC into the construction industry.

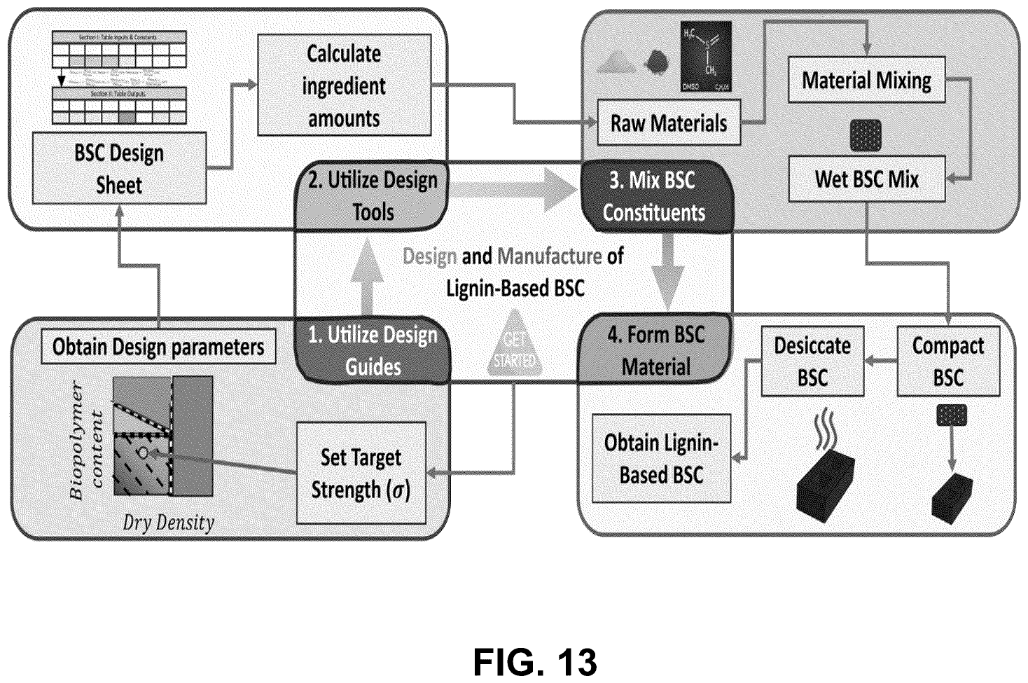

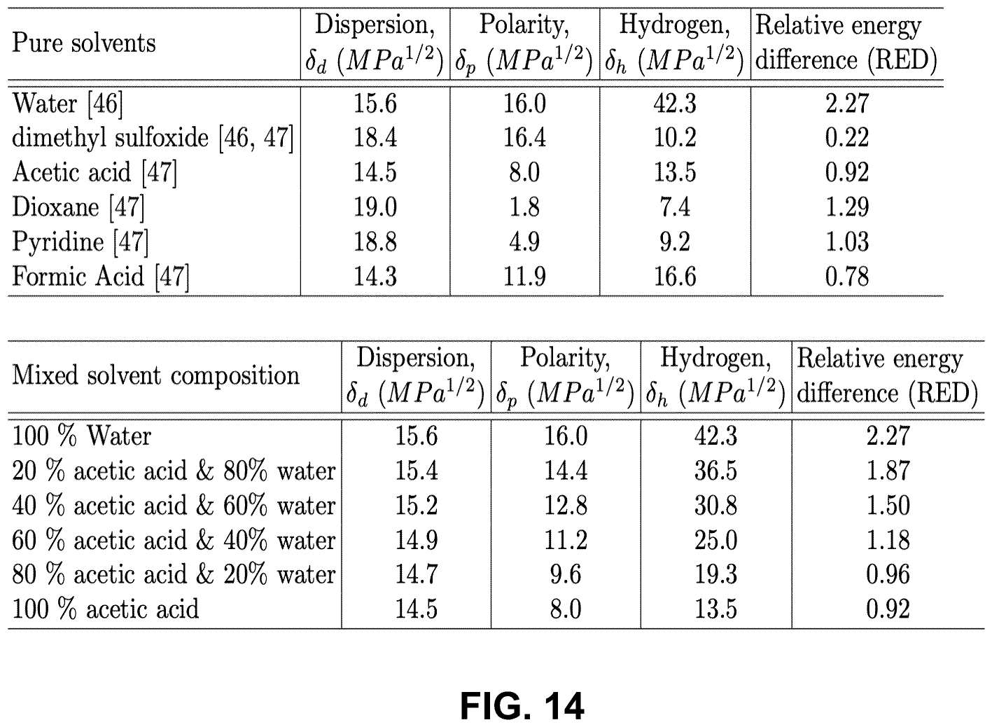

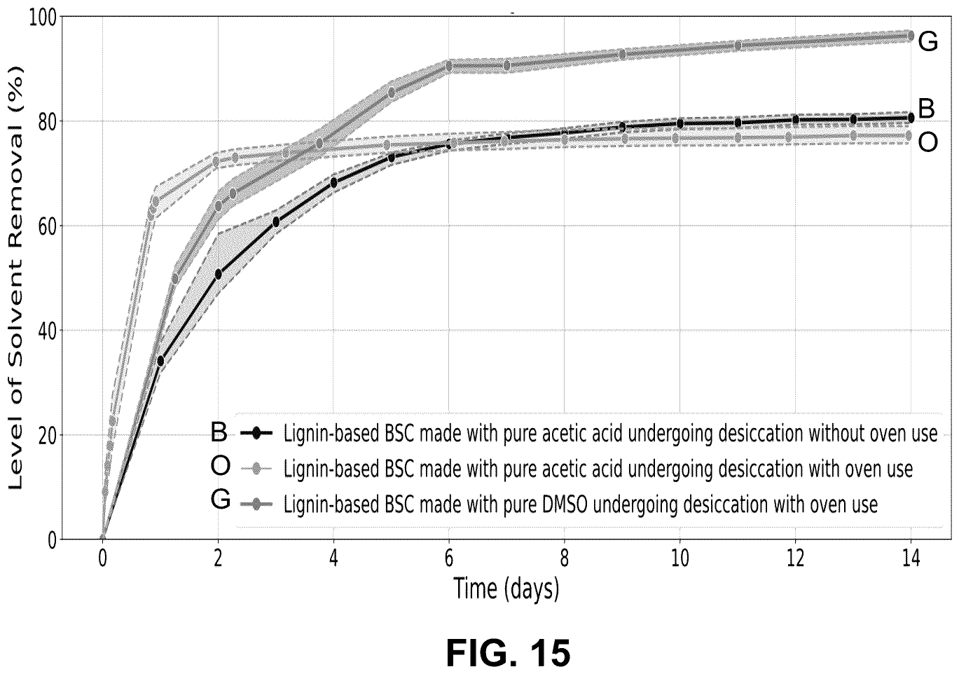

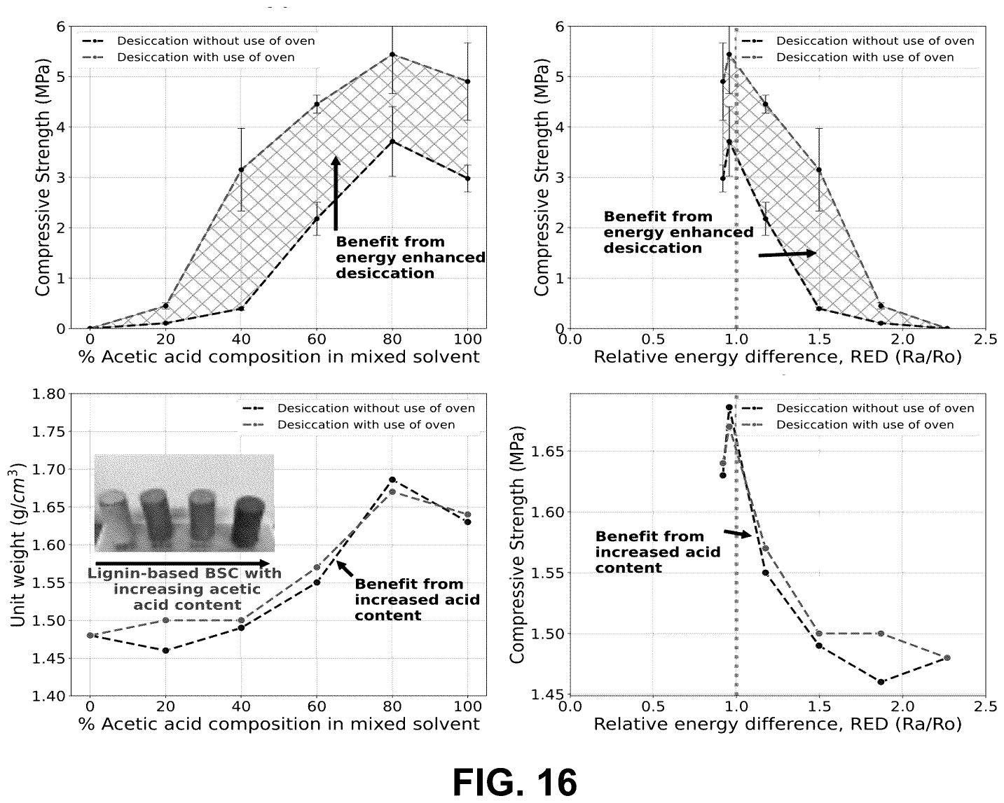

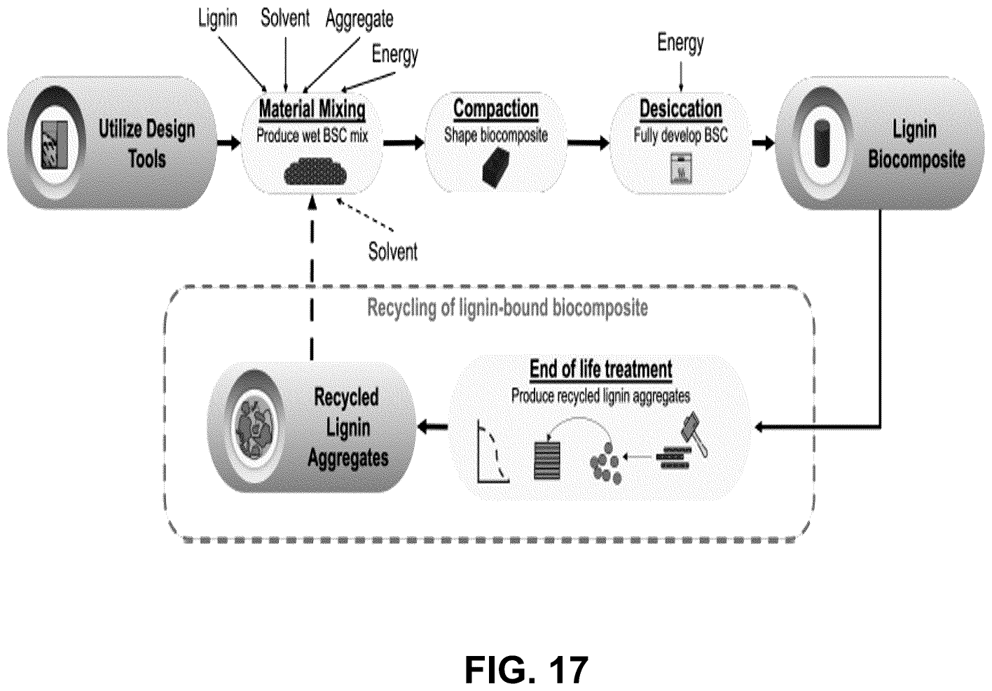

FIG. 13 shows the general principles for design and manufacture of lignin-based BSC. Dry bulk soil density, although it cannot be directly specified in the manufacture of lignin-based BSC, shows a strong correlation with the compressive strength of the finished material. Minimizing excess biopolymer solution (to keep void saturation ratio≤1) allows higher dry bulk soil density to be achieved in the finished material. Maximizing the dry bulk soil density maximizes the packing of the soil particles in BSC which improves the mechanical interaction between soil particles, contributing to higher compressive strength.

The manufacture of lignin-based BSC involves dissolving lignin into DMSO to create the biopolymer solution. Once the lignin is fully dissolved, the granular material (sand, in this study) is blended with the biopolymer solution to form the wet mix. Simple molds can be used to shape the wet mix.

Upon setting a target design strength, the biopolymer-to-soil ratio can be determined from FIGS. 11A-B. The next decision to be made is the volume of solvent to be used in the mix. The volume of solvent must be sufficient to fully dissolve the biopolymer, but an excess must be avoided to ensure that the volume of the biopolymer solution is kept at or below the volume of voids in the soil. Mixes that use a volume of biopolymer solution that exceeds the void space (i.e., void saturation ratio>1) will tend to exhibit shrinkage cracking during desiccation.

Furthermore, overfilling the predicted void space within the soil will decrease the dry bulk soil density of the finished material, which will, in turn, decrease the compressive strength of the BSC.

A worthwhile option to consider is the addition of cellulose fibers to the biocomposite. This option is worth pursuing as cellulose fibers would be expected to increase the tensile strength of the biocomposite. This is an attractive idea because lignin and cellulose fibers are typically produced in the same industrial processes.

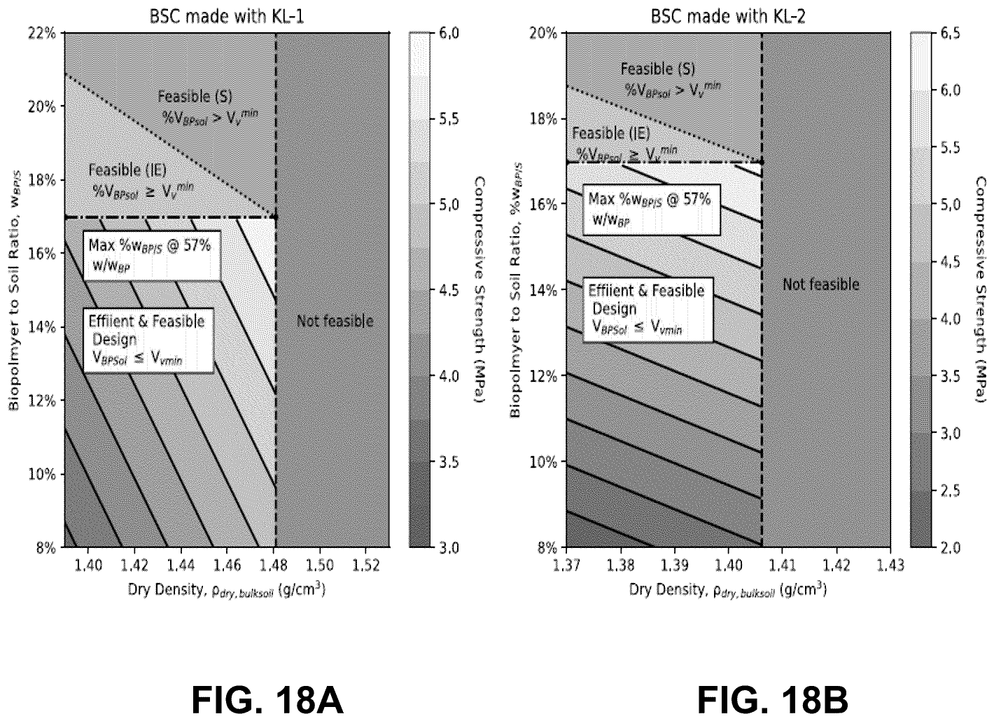

The key innovative aspects of lignin-based composite of this invention are as follows:
1. Solvent selection, namely, the selection of a solvent that is capable of dissolving lignin at high concentrations (at least 20 percent by mass of lignin dissolved into solvent) to form an effective lignin glue to bind together granular material (sand, soil, gravel).
2. The design of a mixed solvent to enhance the strength and evaporation/manufacture of lignin-based composite, namely, identifying the composition of a mixed solvent that would result in the best improvement of both physical strength and desiccation rate. The inventors demonstrated this through the design and implementation of a mixed solvent composed of acetic acid and water, where the most effective mixed solvent was one that was 80 percent by mass acetic acid and 20 percent by mass water.
3. The fabrication method of lignin-based composite, including the mixing time needed to blend the wet mix (the statement about 5 min mixing), the double-sided compaction to ensure proper compaction of the composite, and the desiccation/evaporation settings (i.e., the time needed for solvent evaporation and the temperature for desiccation)
4. The design approach, namely, the design parameters for lignin-based composite (e.g., biopolymer content and dry bulk soil density) made from hydrolysis lignin, alkali lignin, and two variants of kraft lignin (lignoboost lignin and lignoforce lignin). The design relationships are shown in FIGS. 11A-B and FIGS. 18A-B.
5. The minimum content of lignin in the composite must be at least 5 percent by mass in the final composite.
6. The recycling of lignin-based composite at the end of life, in terms of producing recycled lignin aggregates to use in place of virgin lignin and aggregate to fabricate recycled lignin-based composite. The results show that recycled lignin-based composite is stronger than lignin-based composite made from virgin ingredients, which is surprising, given that other comparable materials such as concrete are weaker when recycled.

### CONCLUSIONS

A new variant of BSC, lignin-based BSC, is disclosed that uses lignin as a biopolymer binder. Two types of lignin-hydrolysis lignin and alkali lignin-were used in this study, and both biopolymers yielded viable biocomposites with similar compressive strength. Considering both types of lignin, the inventors achieved compressive strength ranging from 1.6-8.1 MPa, which, according to ASTM C129, allows lignin-based BSC to be used for non-structural construction applications (e.g., pavement, roofing tiles, and non-structural elements), but not for structural construction applications (structural members where OPCC is used). Lignin-based BSC opens a significant new arena in the field of sustainable construction materials.

The use of lignin in the development of this material represents the first use of a non-protein plant-derived biopolymer to facilitate fabrication of a cement-free granular construction material. Unlike existing variants of BSC, which use hydrophilic biopolymers, the use of a hydrophobic biopolymer in this variant of BSC allows it to be implemented in a wider range of environments (locations more prone to humid weather or rainfall). Prior to this invention, BSC used hydrophilic biopolymer binders, which would require the use of protective coatings if they were to be deployed in wet locations. Additionally, the biopolymers used to manufacture lignin-based BSC are sourced from the waste streams of major industries (paper/pulp production and biofuels production facilities), and are independent of the fossil fuel industry. While proteins used in the manufacture of BSC have the advantage of carbon sequestration, this advantage is even greater for BSC made with lignin, as lignin is richer in carbon than most proteins.

The inventors found that hydrolysis lignin was a more efficient binder as compared to alkali lignin for manufacture of lignin-based BSC. The introduction of lignin-based BSC represents a significant step towards developing a cement-free granular construction material and will help foster a green transition in the construction of the built environment.

What is claimed is:

1. A method of making lignin-based composites, comprising:
(a) having a raw-form of lignin, wherein the raw-form of lignin is defined as a hydrophobic and non-synthetic lignin obtained from a manufacturer without any further chemical processing done to the obtained hydrophobic lignin;
(b) dissolving the raw-form of lignin into a solvent thereby forming a lignin-glue and wherein the solvent has fully been evaporated or dissolved at a temperature less or equal than 60 degrees Celsius, at an atmospheric pressure of less or equal than 1 atmosphere and within 7 days; and
(c) mixing the lignin-glue with aggregates to form a composite, wherein the lignin-glue binds to the aggregates in the composite, wherein there is at least 5 percent by mass of lignin in the composite.

2. The method as set forth in claim 1, wherein the aggregate is sand, gravel, or soil.

3. The method as set forth in claim 1, wherein the raw-form of lignin is obtained from the manufacturer using a kraft process, a hydrolysis process, or an alkali process.

4. The method as set forth in claim 1, wherein the aggregate is a regolith matter or a granular matter.

5. A method of reusing lignin-based composites to make a new recycled lignin-based composite, comprising:
(a) having recycled lignin-based composite aggregates, wherein the recycled lignin-based composite aggregates are defined as a material obtained from crushing of lignin-based composites at an end of a design life.
(b) adding a solvent to reactivate a lignin binder on the recycled lignin-based composite aggregates and wherein the solvent has fully been evaporated or dissolved at a temperature less or equal than 60 degrees Celsius, at an atmospheric pressure of less or equal than 1 atmosphere and within 7 days; and
(c) mixing the reactivated lignin-based composite aggregates to reform a new recycled lignin-based composite wherein there is at least 5 percent by mass of lignin in the composite.

6. A method of enhancing the strength of manufactured lignin-based composites using mixed solvents, comprising:
(a) using a mixed solvent composed of water and non-aqueous solvents for enhancing a binding strength of a lignin glue;
(b) dissolving a raw-form of lignin into the mixed solvent, wherein the mixed solvent has been evaporated or dissolved at a temperature less or equal than 60 degrees Celsius, at an atmospheric pressure of less or equal than 1 atmosphere and within 2 days; and
(c) mixing the enhanced lignin-glue with aggregates to form a stronger composite, wherein the enhanced lignin-glue binds to aggregates in a composite, wherein there is at least 5 percent by mass of lignin in the composite.

7. The method as set forth in claim 1, wherein the lignin glue is formed through acetylation of a lignin biopolymer when a mixed solvent composed of water and acetic acid is used.
